(19) United States
(12) Patent Application Publication
(10) Pub. No.: US 2026/0149538 A1
(43) Pub. Date: May 28, 2026

(54) ENDPOINT CLASS-BASED PERFORMANCE ISOLATION IN A HIGH-PERFORMANCE INTERCONNECT

(71) Applicant: Hewlett Packard Enterprise Development LP, Spring, TX (US)

(72) Inventors: Pedro H. R. Bruel, San Jose, CA (US); Dejan S. Milojicic, Palo Alto, CA (US); Sai Rahul Chalamalasetti, Newark, CA (US); Aditya Dhakal, Santa Clarita, CA (US); Laurence Scott Kaplan, Shoreline, WA (US); Duncan Roweth, Bristol (GB)

(21) Appl. No.: 18/978,894

(22) Filed: Dec. 12, 2024

Related U.S. Application Data
(60) Provisional application No. 63/725,864, filed on Nov. 27, 2024.

(51) Int. Cl. H04L 5/00; H04W 72/0453

(52) U.S. Cl. CPC H04L 5/0044; H04W 72/0453

(57) ABSTRACT

A system receives, by a network device in a network fabric, a packet comprising at least one of a traffic-class value for a traffic-class type and an endpoint-class value for an endpoint-class type. The system extracts the traffic-class value and the endpoint-class value from the packet and determines a hierarchical class structure, which indicates: priorities associated with types of classes, comprising a first priority associated with the traffic-class type and a second priority associated with the endpoint-class type; and bandwidth allocation ratios for values in a respective class type, comprising first bandwidth allocation ratios for values of the traffic-class type and second bandwidth allocation ratios for values of the endpoint-class type. The system determines a bandwidth allocation for the packet based on the extracted values and the hierarchical class structure and forwards the packet based on the determined bandwidth allocation for the packet.

### RELATED APPLICATION

This application claims the benefit of U.S. Provisional Application No. 63/725,864, Attorney Docket Number HPE-P175832USP, entitled “ENDPOINT CLASS-BASED PERFORMANCE ISOLATION IN A HIGH-PERFORMANCE INTERCONNECT,” by Pedro H. R. Bruel, Dejan S. Milojicic, Sai Rahul Chalamalasetti, Aditya Dhakal, Laurence Scott Kaplan, and Duncan Roweth, filed 27 Nov. 2024.

### BACKGROUND

Current traffic management rules can prioritize traffic based on different traffic classes associated with different requirements and serving different Quality of Service (QoS) policies. However, using these non-hierarchical class-based QoS metrics in current traffic management rules does not account for different types of endpoints.

### BRIEF DESCRIPTION OF THE FIGURES

FIG. 1A illustrates an environment facilitating endpoint class-based performance isolation in a high-performance interconnect, in accordance with an aspect of the present application.

FIG. 1B illustrates an environment facilitating endpoint class-based performance isolation in a high-performance interconnect, including packet headers and fabric headers, in accordance with an aspect of the present application.

FIG. 2 illustrates a diagram depicting the extension of endpoint-class control to traffic-class control in traffic management, in accordance with an aspect of the present application.

FIG. 3 illustrates a diagram depicting the extension of source/destination-class control to endpoint-class control and traffic-class control at the switch level, in accordance with an aspect of the present application.

FIG. 4 illustrates a diagram depicting the distribution of weights for combinations of QoS class-types, including a traffic-class type, an endpoint-class type, and a source/destination-class type, in accordance with an aspect of the present application.

FIG. 5A illustrates a diagram depicting prioritization of QoS classes in a non-hierarchical fashion, in accordance with an aspect of the present application.

FIG. 5B illustrates a diagram depicting prioritization of QoS classes as a hierarchical class structure using the traffic-class type, the endpoint-class type, and the source/destination-class type, in accordance with an aspect of the present application.

FIG. 5C illustrates a diagram depicting prioritization of QoS classes as a hierarchical class structure using the endpoint-class type, the traffic-class type, and the source/destination-class type, in accordance with an aspect of the present application.

FIG. 6 presents a flowchart illustrating a method which facilitates endpoint class-based performance isolation in a high-performance interconnect, in accordance with an aspect of the present application.

FIG. 7A presents a flowchart illustrating a method which facilitates determining bandwidth allocation and forwarding packets using the endpoint-class type, in accordance with an aspect of the present application.

FIG. 7B presents a flowchart illustrating a method which facilitates providing latency-critical support using the endpoint-class type, in accordance with an aspect of the present application.

FIG. 8 illustrates a computer system (e.g., a network device) which facilitates endpoint class-based performance isolation in a high-performance interconnect, in accordance with an aspect of the present application.

FIG. 9 illustrates a computer-readable medium which facilitates endpoint class-based performance isolation in a high-performance interconnect, in accordance with an aspect of the present application.

In the figures, like reference numerals refer to the same figure elements.

### DETAILED DESCRIPTION

Aspects of the present application extend non-hierarchical class-based QoS metrics (e.g., “traffic-class type”) for managing traffic by utilizing two additional types of classes: an “endpoint-class type”; and a “source/destination-class type.” The additional class types may enable decision-making for traffic management based on per-endpoint-class performance objectives, which can result in more efficient forwarding and resource distribution.

Current traffic management rules can prioritize traffic using a non-hierarchical class-based QoS metric, i.e., based on different traffic classes associated with different requirements and serving different QoS policies (also referred to as the traffic-class type). However, using only non-hierarchical class-based QoS metrics in current traffic management rules does not account for different types of endpoints. In some high-performance interconnect networks, the lack of endpoint-class specific traffic control may lead to non-ideal utilization of resources and sub-optimal forwarding, which may result in inefficient or unfair resource distribution.

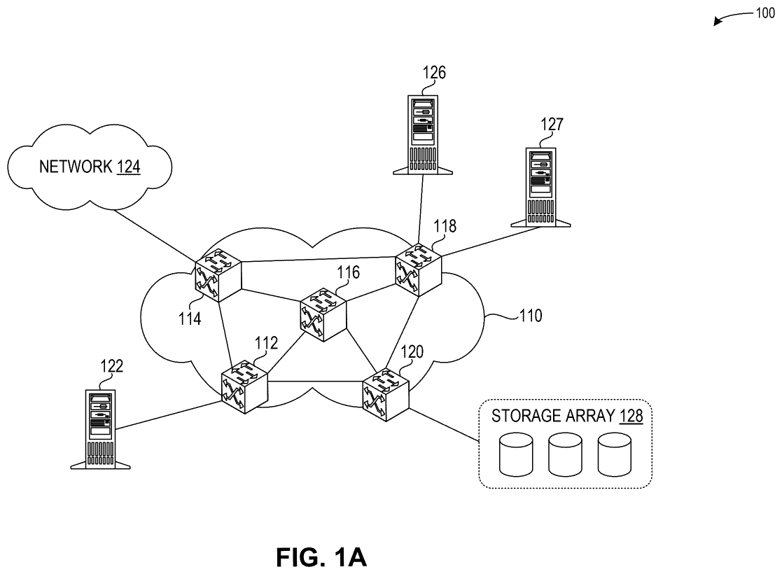

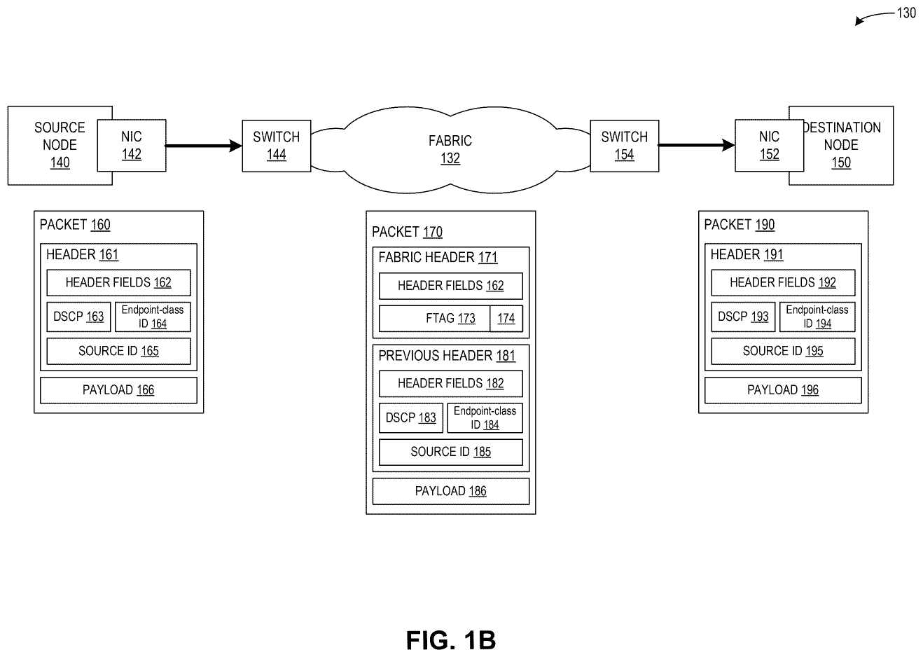

The present inventive solution addresses the limitations of current traffic management rules by extending non-hierarchical class-based QoS metrics with two additional types of classes: an endpoint-class type; and a source/destination-class type. Packets may travel from a source endpoint to a destination endpoint through a network fabric, e.g., a network of switches, as described below in relation to FIG. 1A. Values of the endpoint-class type can indicate a class of a component or device coupled to the network fabric and to which a packet is to be transmitted (e.g., a storage-based endpoint class or a compute-based endpoint class, or a graphics processing unit (GPU)-based endpoint class or central processing unit (CPU)-based endpoint class). Values of the source/destination-class type can indicate a priority between a source and a destination of a packet (or between a group of sources and a group of destinations).

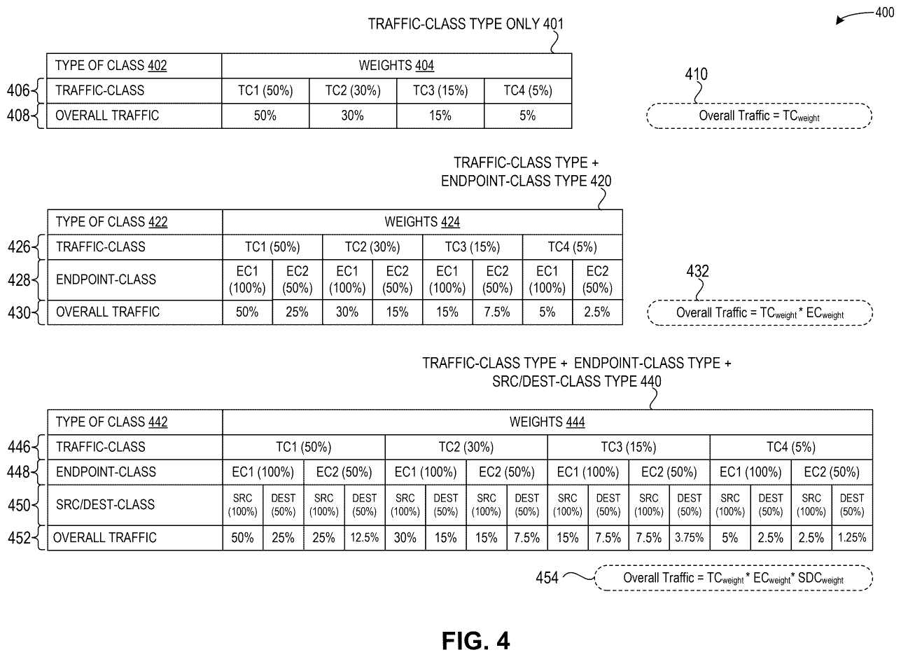

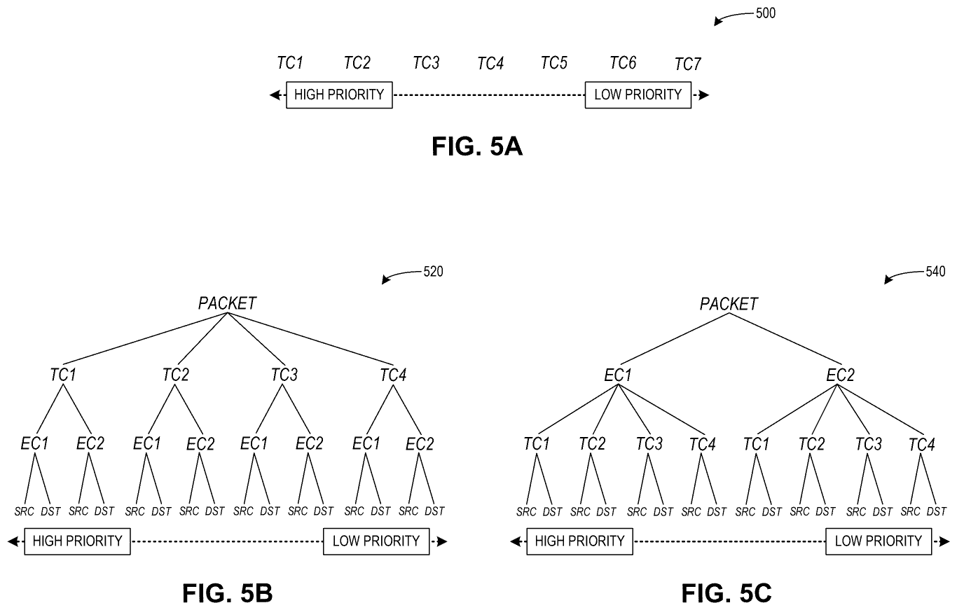

The system (or an administrative user) may configure: the class types with relative priorities between each class type (e.g., [traffic, endpoint, source/dest] or [endpoint, traffic]); and the values in each class type with bandwidth allocation ratios between each class value (e.g., [traffic to endpoint class A is to receive 50% of the bandwidth of traffic to endpoint class B] or [traffic flowing from a certain type of source (or group of sources) has priority over traffic flowing to a certain type of destination (or group of destinations]). These configured values may be represented as weights and by a hierarchical class structure (e.g., a tree), as described below in relation to FIGS. 4A, 5B, and 5C.

Thus, any switch in a network fabric can receive a packet indicating values for one or more class types, e.g., values for the traffic-class type, the endpoint-class type, and the source/destination-class type. The switch can determine a bandwidth allocation based on the indicated values and a traversal of the hierarchical class structure. For example, the switch may identify a subclass by traversing the hierarchical class structure, and the subclass may be associated with a certain priority, e.g., configured in order of priority by class type and by bandwidth allocation ratios between values of a certain class type. The switch can forward the packet based on the determined bandwidth allocation. Determining the bandwidth allocation ratio for a packet and forwarding the packet based on the determined bandwidth allocation ratio is described below in relation to FIGS. 4A, 5B, 5C, and 7A.

By extending the standard non-hierarchical traffic-class type with the endpoint-class type and the source/destination-class, the described aspects can provide additional granularity and precision for applying traffic management rules when forwarding packets through a network fabric. Furthermore, by configuring priority information between class types and configuring bandwidth allocation ratios between class values of a given class type, the described aspects can result in a more efficient and fair distribution of resources in a network fabric and overall system.

FIG. 1A illustrates an environment 100 facilitating endpoint class-based performance isolation in a high-performance interconnect, in accordance with an aspect of the present application. Environment 100 can include a network 110 of switches which can be referred to as a “network fabric” or a “switch fabric” and can include switches 112, 114, 116, 118, and 120. Network fabric 110 may be a high-performance interconnect. Each switch can have a unique address or identifier within switch fabric 110. Various types of endpoints, processing nodes, devices, and networks can be coupled to a switch fabric. For example, an endpoint device or end host 122 may be coupled to network fabric 110 via switch 112; a network 124 may be coupled to network fabric 110 via switch 114; a number of other end hosts, such as hosts 126 and 127, may be coupled to network fabric 110 via switch 118; and a storage array 128 may be coupled to network fabric 110 via switch 120. Network 124 may be a high-performance computing (HPC) network (e.g., InfiniBand, Slingshot, or any other high-performance network), which may include multiple networked computer and storage devices concurrently running programs to complete different complex and performance-intensive tasks. Network 124 may also be an Internet Protocol (IP)/Ethernet network, which may include physical Ethernet cabling and an application layer protocol between network devices based on IP, including communication via Transport Communication Protocol (TCP)/IP and User Datagram Protocol (UDP) packets. Network fabric 110 may itself be an Ethernet network or an HPC network (i.e., a high-performance interconnect).

A switch may include one or more ports. For example, in a switch in a network fabric, an edge port can couple to a device that is external to the fabric, and a fabric port can couple to another switch within the fabric via a fabric link. Typically, traffic may be injected into network fabric 110 via an ingress port of an edge switch and may leave network fabric 110 via an egress port of another (or the same) edge switch. An ingress link can couple a network interface controller (NIC) of an edge device (e.g., an HPC end host) to an ingress edge port of an edge switch. Network fabric 110 can then transport the traffic to an egress edge switch, which in turn can deliver the traffic to a destination edge device via another NIC. A packet can be forwarded in network fabric 110 based on its Layer-2 address (“fabric address”), which may be viewed as an equivalent to a media access control (MAC) address in Ethernet. The forwarding path for the packet may be determined based on adaptive forwarding, e.g., based on local programming of the switches in switch fabric 110 and information related to load, traffic, and congestion available to and associated with switch fabric 110. The packet may also be routed based on other protocols, e.g., based on IP in network 124 or across network fabric 110.

FIG. 1B illustrates an environment 130 facilitating endpoint class-based performance isolation in a high-performance interconnect, including packet headers and fabric headers, in accordance with an aspect of the present application. Environment 130 can include: a source node 140 with a NIC 142; a network fabric 132 with at least a switch 144 and a switch 154; and a destination node 150 with a NIC 152. Source node 140 and destination node 150 may correspond to, respectively, devices 122 and 126 of FIG. 1A, and network fabric 132 may correspond to network fabric 110 of FIG. 1A.

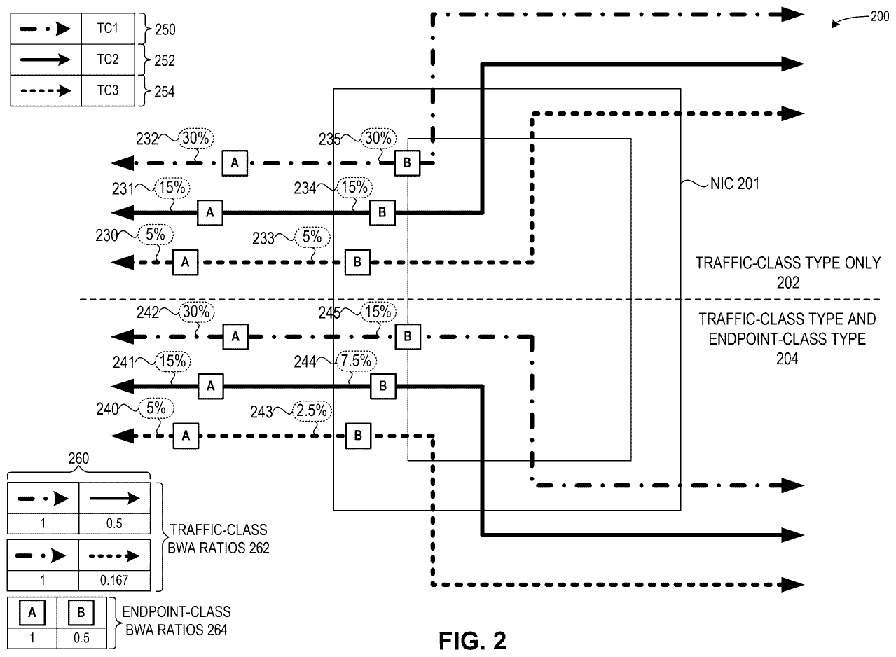

The switches in network fabric 132 may be configured to handle certain types of traffic, including one or more of a traffic-class type, an endpoint-class type, and a source/destination-class type. Each switch may store information relating to a forwarding priority (“forwarding priority information”) in a hierarchical class structure. The stored information may be configured to indicate both a priority by class type and by desired bandwidth allocation ratios between values of a certain class type, as described below in relation to FIGS. 2-4, 5B, and 5C. Each switch may store a same or a different configuration than other switches in the network fabric, and the configuration may be dynamically modified based on predetermined policies or monitored conditions.

During operation, source node 140 may send a packet 160 to destination node 150 through fabric 132. Packet 160 can include a header 161 and a payload 166. Header 161 can include: header fields 162; Differentiated Services Code Point (DSCP) information 163 which classifies the network traffic; an endpoint-class identifier (ID) 164; and a source identifier (ID) 165. Source node 140, via its NIC 142, may send the packet to switch 144.

Upon receiving packet 160, switch 144 (as an ingress edge switch) may encapsulate the packet with a fabric header, resulting in an encapsulated packet 170 which includes a fabric header 171, a previous header 181, and a payload 186. Previous header 181 can include the same fields as header 161, labeled as: header fields 182; DSCP 183; an endpoint-class ID 184; and a source ID 185. Payload 186 can correspond to payload 166. Fabric header 171 can include at least: header fields 162; and a forwarding tag (FTAG) 173 which includes a portion 174. Portion 174 may include bits which indicate an endpoint-class value for an endpoint-class type and a source/destination-class value for a source/destination-class type.

Packet 170 is depicted for illustrative purposes only. Other header configurations may be possible. For example, in a Virtual Extensible Local Area Network (VxLAN), Ethernet frames may be encapsulated within Universal Datagram Protocol (UDP) datagrams, in which case fabric header 171 may be an outer IP header (such as a VxLAN header) with the original header (i.e., previous header 181) being the inner header. In such a network, the information depicted above in FTAG 173 (e.g., an indicator of an endpoint-class value for an endpoint-class type and a source/destination-class value for a source/destination-class type) may be included in another DSCP field in the outer IP header. Thus, switch 144 may extract the traffic-class value, the endpoint-class value, and the source/destination-class value from the packet based on information indicated in: a header specific to or associated with the network fabric, e.g., fabric header 171; or a header associated with a protocol used external to the network fabric, e.g., header 161/previous header 181 or an outer IP header (not depicted). Furthermore, while fabric header 171 is depicted in packet 170 and the information in fabric header 171 may be used by network devices in network fabric 132 to manage traffic, any non-fabric switches which receive a packet with fabric header 171 may ignore fabric header 171 without breaking the protocol indicated by previous header 181.

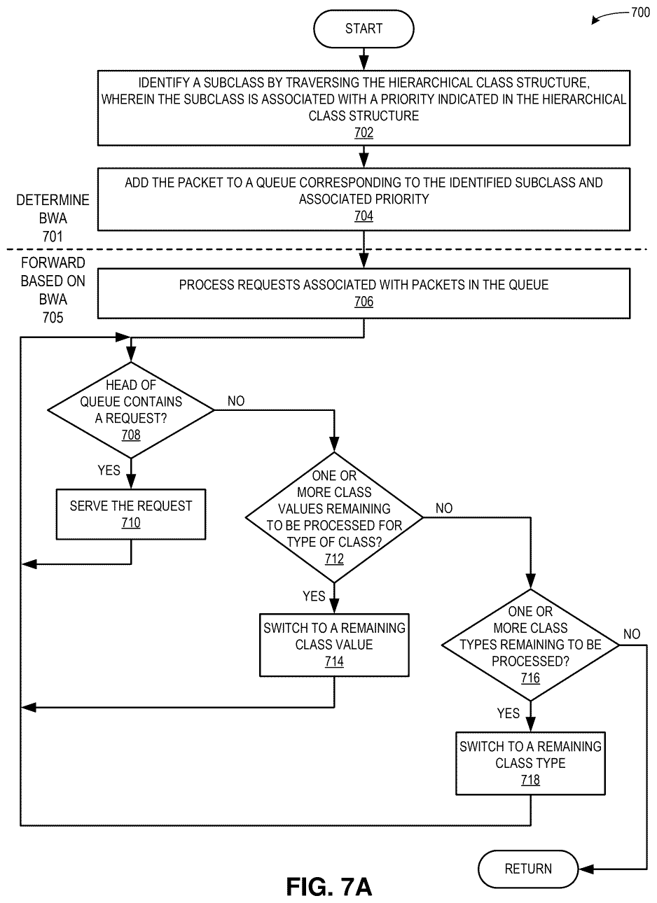

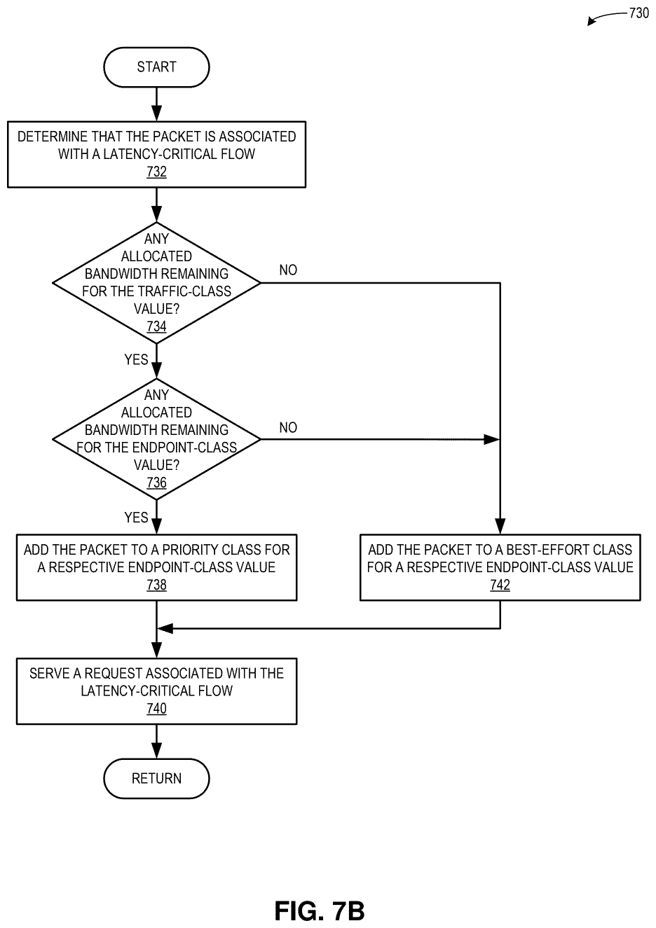

Switch 144 may use the information in packet 160 as well as its configured information associated with the hierarchical class structure to include information (e.g., specific class values) in fabric header 171 relating to the extension of the other two types of classes (i.e., endpoint-class type and source/destination-class type). Switch 144 may place packet 170 in a queue based on the specific class values and the hierarchical class structure, as described below in relation to FIG. 7A. Switch 144 may forward packet 170 to switch 154 based on the queue in which packet 170 is placed. Inserting the packet into a queue for subsequent processing is based on determining the bandwidth allocation for the packet, and the bandwidth allocation for a packet is determined based on at least one of the traffic-class value, the endpoint-class value, and the source/destination-value, as described below in relation to FIGS. 2-4, 5B, and 5C. Packet 170 may travel through multiple intermediate switches (not shown) in network fabric 132 prior to reaching switch 154. Each switch, including the edge and intermediate switches, in network fabric 132 can forward the packet based on its uniquely configured forwarding priority information, which includes the hierarchical class structure and associated information (e.g., priority by class type and bandwidth allocation ratios between values of a certain class type).

Switch 154 (as an egress edge switch) may decapsulate packet 170 by removing fabric header 171 to obtain a packet 190. Packet 190 may be similar to packet 160 prior to entering fabric 132. Packet 190 can include a header 191 and a payload 196. Header 191 can include: header fields 192; DSCP 193; an endpoint-class ID 194; and a source ID 195. Switch 154 may send packet 190 to destination node 150, and destination node 150, via its NIC 152, may receive packet 190.

Thus, the configured forwarding priority information (i.e., the hierarchical class structure indicating relative priorities and bandwidth allocation ratios) can provide additional granularity and precision for applying traffic management rules when forwarding packets through a network fabric. By extending the standard non-hierarchical traffic-class type with the endpoint-class type and the source/destination-class, the described aspects can provide an improvement to the performance and efficiency not only of a single network device (e.g., a switch) in a network fabric, but also of the entire network fabric and system.

FIG. 2 illustrates a diagram 200 depicting the extension of endpoint-class control to traffic-class control in traffic management, in accordance with an aspect of the present application. The top half (202) of diagram 200 depicts managing traffic in a NIC 201 based on the traffic-class type only. The bottom half (204) of diagram 200 depicts managing traffic in NIC 201 based on the endpoint-class type as well as the traffic-class type. Three data flows are depicted in each of the top half and the bottom half. For example: a dotted-dashed line indicates data of a traffic-class type “TC1” (250); a solid line indicates data of a traffic-class type “TC2” (252); and a dashed line indicates a traffic-class type “TC3” (254).

In addition, NIC 201 can use configured forwarding priority information to determine traffic management rules. For example, target or desired bandwidth allocation ratios 260 may include traffic-class bandwidth allocation (BWA) ratios 262 and endpoint-class bandwidth allocation ratios 264. For example, traffic of traffic-class type TC1 can be allocated two times as much bandwidth as traffic of traffic-class type TC2 (indicated as 1 to 0.5), and traffic of traffic-class type TC1 can be allocated six times as much bandwidth as traffic of traffic-class type TC3 (indicated as 1 to 0.167). Furthermore, traffic of endpoint-class type “A” can be allocated two times as much bandwidth as traffic of endpoint-class type “B” (indicated as 1 to 0.5).

As depicted in section 202, traffic of traffic-class type TC1 may receive 30% BWA, regardless of whether the endpoint-class type is A or B (as indicated by “30%” in elements 232 and 235). Similarly, traffic of traffic-class type TC2 may receive 15% BWA, which follows the configured BWA ratio of 1 to 0.5 between TC1 and TC2. However, the endpoint-class type again does not affect the BWA (as indicated by “15%” in elements 231 and 234). In addition, traffic of traffic-class type TC3 may receive 5% BWA, which follows the configured BWA ratio of 1 to 0.167 between TC1 and TC3. Again, the endpoint-class type is not accounted for in the BWA (as indicated by “5%” in elements 230 and 233).

As depicted in section 204, adding the endpoint-class type to the traffic-class type when managing traffic through NIC 201 provides a granularity which can increase the accuracy and effectiveness of the traffic management. In section 204, traffic of traffic-class type TC1 may receive 30% BWA, but the allocated BWA will further depend on whether the endpoint-class type is A or B following the configured BWA ratio of 1 to 0.5 between A and B (as indicated by “30%” for endpoint-class type A in element 242 and as indicated by “15%” for endpoint-class type B in element 245). Similarly, traffic of traffic-class type TC2 may receive 15% BWA, which follows the configured BWA ratio of 1 to 0.5 between TC1 and TC2. In addition, the allocated BWA will further depend on whether the endpoint-class type is A or B following the configured BWA ratio of 1 to 0.5 between A and B (as indicated by “15%” for endpoint-class type A in element 241 and as indicated by “7.5%” for endpoint-class type B in element 244). Furthermore, traffic of traffic-class type TC3 may receive 5% BWA, which follows the configured BWA ratio of 1 to 0.167 between TC1 and TC3, and the allocated BWA will further depend on whether the endpoint-class type is A or B following the configured BWA ratio of 1 to 0.5 between A and B (as indicated by “5%” for endpoint-class type A in element 240 and as indicated by “2.5%” for endpoint-class type B in element 243).

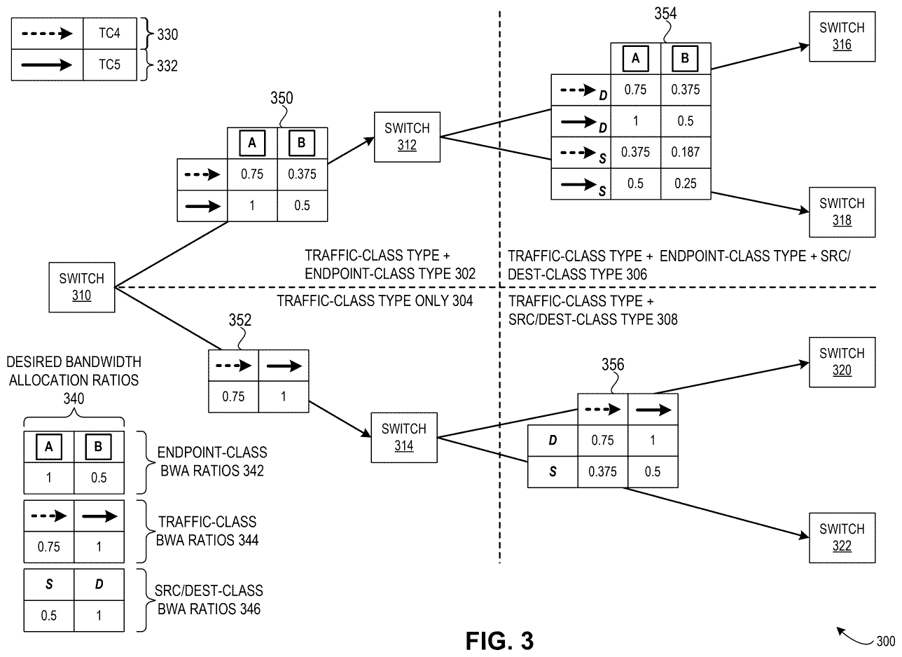

FIG. 3 illustrates a diagram 300 depicting the extension of source/destination-class control to endpoint-class control and traffic-class control at the switch level, in accordance with an aspect of the present application. Diagram 300 can depict traffic flowing in a network fabric, e.g.: from a switch 310 to switches 312 and 314; from switch 312 to switches 316 and 318; and from switch 314 to switches 320 and 322. The number of switches depicted in diagram 300 is presented for illustrative purposes. More or fewer switches may be used in a network fabric. Traffic-class type “TC4” can be indicated with a dashed line (330) and traffic-class type “TVC5” can be indicated with a solid line (332).

Each switch can also use configured forwarding priority information when processing packets to be forwarded by a respective switch. For example, target or desired bandwidth allocation (BWA) ratios 340 may include: endpoint-class BWA ratios 342; traffic-class BWA ratios 344; and source/destination-class BWA ratios 346. For example: traffic of endpoint-class type “A” can be allocated two times as much bandwidth as traffic of endpoint-class type “B” (indicated as 1 to 0.5); traffic of traffic-class type TC4 can be allocated 0.75 times as much bandwidth as traffic of traffic-class type TC5 (indicated as 0.75 to 1); and traffic of source/destination-class type “source” (S) can be allocated half as much bandwidth as traffic of source/destination-class type “destination” (D) (indicated as 0.5 to 1).

Each switch in a network fabric may use the same or different bandwidth allocation ratios. The bandwidth allocation ratios may depend upon the type of node from which traffic originates or is destined. For example, bandwidth allocation ratios on switches which connect to client nodes may be different from bandwidth allocation ratios on switches that connect to storage servers or a data center. Diagram 300 depicts configured bandwidth allocation ratios for different class types and combinations of class types. For example: BWA ratios 350 can be used by switch 310 when forwarding data to switch 312 (traffic-class type+endpoint-class type 302 traffic management); BWA ratios 352 can be used by switch 210 when forwarding data to switch 314 (traffic-class type only 304 traffic management); BWA ratios 354 can be used by switch 312 when forwarding data to switches 316 and 318 (traffic-class type+endpoint-class type+source/destination-class type 306 traffic management); and BWA ratios 356 can be used by switch 314 when forwarding data to switches 320 and 322 (traffic-class type+source/destination-class type 308 traffic management).

By applying the configured bandwidth allocation ratios in the configured priority or combination at a specific switch, the described aspects can forward traffic with improved efficiency based on the additional granularity of the two additional class types. For example, using desired BWA ratios 340 and specifically based on the configured BWA ratios 350 (e.g., based on both the traffic-class type and the endpoint-class type), switch 310 can forward traffic to switch 312 based on: traffic-class type TC4 and endpoint-class type A using 0.75 BWA; traffic-class type TC4 and endpoint-class type B using a 0.375 BWA; traffic-class type TC5 and endpoint-class type A using 1 BWA; and traffic-class type TC5 and endpoint-class type B using a 0.5 BWA. Each switch may use different configured BWA ratios for different ports, paths, or links to other switches. For example, in addition to forwarding traffic to switch 312 based on the traffic-class type and the endpoint-class type (traffic management 302), switch 310 can forward traffic to switch 312 based on only the traffic-class type: traffic-class type TC4 using 0.75 BWA; and traffic-class type TC5 using 1 BWA. In addition, switches 312 and 314 can use BWA ratios 354 and 356 for forwarding traffic to, respectively, switches 316/318 and 320/322. Each switch can also configure the priority for each class type, as described below in relation to FIGS. 5A-C.

FIG. 4 illustrates a diagram 400 depicting the distribution of weights for combinations of QoS class-types, including a traffic-class type, an endpoint-class type, and a source/destination-class type, in accordance with an aspect of the present application. Diagram 400 can include: a traffic-class type only table 401; a traffic-class type and endpoint-class type table 420; and a traffic-class type, endpoint-class type, and source/destination-class type table 440. Each table can include a bandwidth allocation ratio distribution (e.g., an assigned “weight” represented as a percentage) for the included class type (or types) of a first value against another value (or values) of the same class as well as an overall BWA. The included class types may be ordered based on a configured priority (e.g., along with the assigned weights as part of the configured forwarding priority information). The overall traffic for each table can be summarized by multiplying the assigned weight for a class type with the assigned weight (or weights) for the other class type (or class types).

Table 401 indicates a type of class 402 and weights 404, with a row 406 indicating weights for a traffic-class type (e.g., TC1 50%, TC2 30%, TC3 15%, and TC4 5%). Since table 401 depicts only one type of class, a row 408 indicates that the overall traffic using the assigned weights in table 401 (i.e., the BWA ratios) is the actual assigned weight for the traffic-class (TC) type: Overall Traffic=TC_{weight} (410).

Table 420 indicates a type of class 422 and weights 424, with two rows indicating weights for two class types: a row 426 indicates weights for a traffic-class type (e.g., TC1 50%, TC2 30%, TC3 15%, and TC4 5%); and a row 428 indicates weights for an endpoint-class type (e.g., EC1 100% and EC2 50%) within each traffic-class type. The ordering of rows 426 and 428 indicate that the traffic-class type has a higher priority than the endpoint-class type, which is why the endpoint-class type weights are listed per traffic-class type. Since table 420 depicts two class types, a row 430 indicates that the overall traffic using the assigned weights in table 420 (i.e., the BWA ratios) is the actual assigned weight for the traffic-class type multiplied by the actual assigned weight for the endpoint-class (EC) type: Overall Traffic=TC_{weight}*EC_{weight} (432).

Table 440 indicates a type of class 442 and weights 444, with three rows indicating weights for three class types: a row 446 indicates weights for a traffic-class type (e.g., TC1 50%, TC2 30%, TC3 15%, and TC4 5%); a row 448 indicates weights for an endpoint-class type (e.g., EC1 100% and EC2 50%) within each traffic-class type; and a row 450 indicates weights for a source/destination-class type (e.g., Src 100% and Dest 50%) within each endpoint-class type. The ordering of rows 446, 448, and 450 indicate that the traffic-class type has a higher priority than the endpoint-class type, which has a higher priority than the source/destination-type class. As a result, the endpoint-class type weights are listed per traffic-class type and the source/destination-class type weights are listed per endpoint-class type. Since table 440 depicts three class types, a row 452 indicates that the overall traffic using the assigned weights in table 440 (i.e., the BWA ratios) is the actual assigned weight for the traffic-class type multiplied by the actual assigned weight for the endpoint-class type and further multiplied by the actual assigned weight for the source/destination-class (SDC) type:

$$Overall Traffic = {TC}_{w e ight} * {EC}_{w e ight} * SD {C}_{w e i g h t} . \qquad ( 454 )$$

FIG. 5A illustrates a diagram 500 depicting prioritization of QoS classes using the traffic-class type only, in accordance with an aspect of the present application. In diagram 500, the traffic-class type values for TC1-TC7 may be configured in an order of priority with TC1 given the highest priority and TC7 given the lowest priority. Diagram 500 represents the non-hierarchical class-based QoS metrics described herein.

FIG. 5B illustrates a diagram 520 depicting prioritization of QoS classes as a hierarchical class structure using the traffic-class type, the endpoint-class type, and the source/destination-class type, in accordance with an aspect of the present application. Diagram 520 may correspond to table 440 of FIG. 4. In diagram 520, the traffic-class values for TC1-TC4 may be configured in an order of priority with TC1 given the highest priority and TC4 given the lowest priority (among the traffic-class values, e.g., as indicated by row 446 in FIG. 4). The endpoint-class values for EC1 and EC2 may be configured in an order of priority with EC1 given higher priority over EC2 (among the endpoint-class values, e.g., as indicated by row 448 in FIG. 4). The source/destination values may be configured in an order of priority with Src given higher priority over Dest (among the source/destination-class values, e.g., as indicated by row 450 in FIG. 4). As depicted by the hierarchical class structure (tree) in diagram 520, a packet can be allocated bandwidth based first on the traffic-class type (e.g., TC1, TC2, TC3, or TC4), then based on the endpoint-class type (e.g., EC1 or EC2), and finally based on the source/destination-class type (e.g., Src or Dest).

FIG. 5C illustrates a diagram 540 depicting prioritization of QoS classes as a hierarchical class structure using the endpoint-class type, the traffic-class type, and the source/destination-class type, in accordance with an aspect of the present application. In diagram 540, the endpoint-class values for EC1 and EC2 may be configured in an order of priority with EC1 given higher priority over EC2 (among the endpoint-class values). The traffic-class values for TC1-TC4 may be configured in an order of priority with TC1 given the highest priority and TC4 given the lowest priority (among the traffic-class values). The source/destination values may be configured in an order of priority with Src given higher priority over Dest (among the source/destination-class values). As depicted by the hierarchical class structure (tree) in diagram 540, a packet can be allocated bandwidth based first on the endpoint-class type (e.g., EC1 or EC2), then based on the traffic-class type (e.g., TC1, TC2, TC3, or TC4), and finally based on the source/destination-class type (e.g., Src or Dest). While the hierarchical class structures (i.e., tree data structures) in FIGS. 5B and 5C are depicted as balanced (i.e., nodes in the same layer each have the same number of child nodes), the hierarchical class structure may be based on an unbalanced tree data structures (i.e., nodes in the same layer may each have a different number of child nodes).

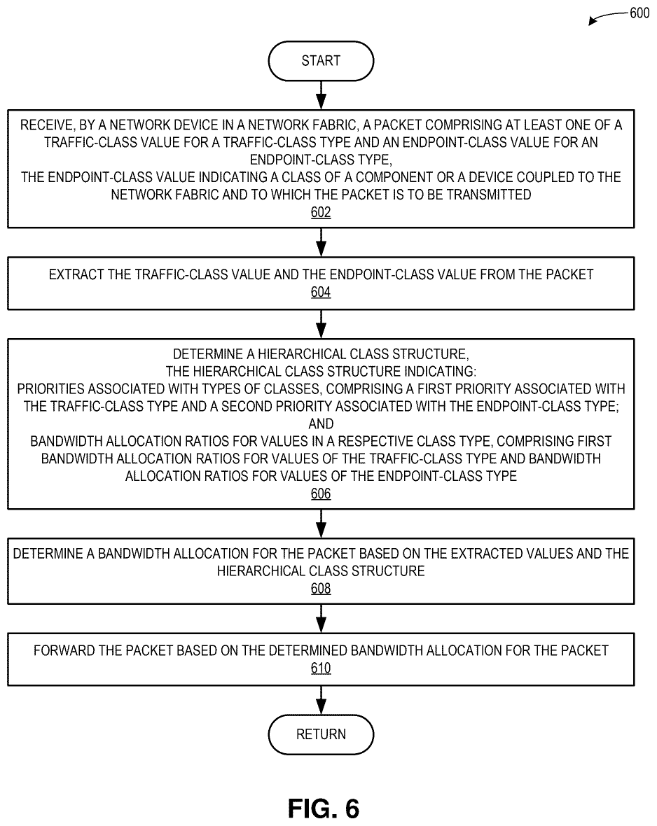

FIG. 6 presents a flowchart 600 illustrating a method which facilitates endpoint class-based performance isolation in a high-performance interconnect, in accordance with an aspect of the present application. During operation, the system receives, by a network device in a network fabric, a packet comprising at least one of a traffic-class value for a traffic-class type and an endpoint-class value for an endpoint-class type, the endpoint-class value indicating a class of a component or a device coupled to the network fabric and to which the packet is to be transmitted (operation 602). The traffic-class value may be included in DSCP information 163 of packet 160 as it enters network fabric 132 (or DSCP information 183 of packet 170 as it travels through network fabric 132). The endpoint-class value may be included as an option in an outer IP header or in a fabric header, e.g., as described above in relation to bit 174 in FTAG 173 in packet 170 of FIG. 1.

The system extracts the traffic-class value and the endpoint-class value from the packet (operation 604). The system can determine the traffic-class value and the endpoint-class value based on information previously configured to correspond with, e.g., a bit 174 set in FTAG 173 of packet 170 in FIG. 1. For example, a value of 0 for the bit may correspond to an endpoint-class value of “A” while a value of 1 for the bit may correspond to an endpoint-class value of “B.” The BWA ratios between endpoint-class values A and B may be configured by each switch in the network fabric, as described above in relation to the switches in FIG. 3.

The system determines a hierarchical class structure, the hierarchical class structure indicating: priorities associated with types of classes, comprising a first priority associated with the traffic-class type and a second priority associated with the endpoint-class type; and bandwidth allocation ratios for values in a respective class type, comprising first bandwidth allocation ratios for values of the traffic-class type and second bandwidth allocation ratios for values of the endpoint-class type (operation 606). For example, the hierarchical class structure can be represented by a tree data structure, with class type priorities defined by the position or layer in the tree data structure, as described above in relation to FIGS. 5B and 5C. The bandwidth allocation ratios can be assigned in terms of priority, as defined by the position of child nodes within the same layer in the tree data structure. The specific bandwidth allocation ratios may be defined as weights, with the value for each class type assigned a certain weight. The calculation for the bandwidth allocation for overall traffic for a packet using the configured relative priorities and bandwidth allocation ratios (i.e., weights) indicated in the hierarchical class structure can be performed as described above in relation to elements 410, 432, and 454 of FIG. 4. The hierarchical class structure can be configured prior to the packet arriving at a switch or changed dynamically upon a packet arriving at the switch. The hierarchical class structure (and the assigned weights for values within each configured and prioritized class type) may be unique to each switch or network device along the path of the packet as the packet travels through the network fabric.

The system determines a bandwidth allocation for the packet based on the extracted values and the hierarchical class structure (operation 608), e.g., by determining the bandwidth allocation ratio for a particular class value of a particular class type and by determining the priority of that particular class type in the hierarchical class structure, as described above in relation to FIGS. 2, 3, 4, 5B, and 5C.

The system forwards the packet based on the determined bandwidth allocation for the packet (operation 610). The system can use the bandwidth allocation determined from operation 608 to identify a subclass for the queue (e.g., based on a traversal of the hierarchical tree structure) and place the packet into a specific queue of a plurality of queues, where a respective queue may correspond to a particular value of a particular class type. The system (e.g., by a scheduler component) may remove packets from the queues for forwarding based on the identified subclass and associated priority for a respective queue. The operation returns.

FIG. 7A presents a flowchart 700 illustrating a method which facilitates determining bandwidth allocation and forwarding packets using the endpoint-class type, in accordance with an aspect of the present application. As described above in relation to FIGS. 1-4, 5B, and 5C, the system can receive traffic to be forwarded based on traffic management rules. For example, the system (i.e., a network device) can receive packets associated with requests and determine a bandwidth allocation for a respective packet, as indicated by operations 702 and 704 in a determine BWA section 701 of FIG. 7A. Section 701 can correspond to operation 608 of FIG. 6. The system can also forward a packet based on the determined bandwidth allocation, as indicated by operations 706-718 in a forward based on BWA section 705 of FIG. 7A. Section 705 can correspond to operation 610 of FIG. 6.

During operation, the system identifies a subclass by traversing the hierarchical class structure, wherein the subclass is associated with a priority indicated in the hierarchical class structure (operation 702). Traversals of example hierarchical class structures are described above in relation to FIGS. 5B and 5C. Relative priorities between class types (e.g., subclasses) are described above in relation to FIGS. 4, 5B, and 5C. The hierarchical class structure may already be configured for use by a switch that receives a packet in a network fabric or may be dynamically configured by the receiving switch while processing traffic associated with the packet.

The system adds the packet to a queue corresponding to the identified subclass and associated priority (operation 704). The system may place the packet in a queue of a plurality of queues based on the specific class values and the hierarchical class structure. Each queue may be an output queue from which packets are to be pulled for forwarding. Each queue may correspond to a particular value of a particular class type (e.g., a subclass and associated priority). A scheduler component of the switch may subsequently remove packets from the queues for forwarding based on the identified subclass and associated priority for a respective queue.

The system can forward the packet based on the determined bandwidth allocation, e.g., by executing a scheduling algorithm on current output queues of the network device. The system processes requests associated with packets in the queue (operation 706). If the head of the queue contains a request (decision 708), the system serves the request (operation 710) and returns to the head of the queue (i.e., back to decision 708). If the head of the queue does not contain a request (decision 708), and if one or more class values remain to be processed for the type of class (decision 712), the system switches to a remaining class value (operation 714) and the operation returns to the head of the queue (i.e., back to decision 708).

If the head of the queue does not contain a request (decision 708), and if one or more class values do not remain to be processed for the type of class (decision 712), and if one or more class types remain to be processed (decision 716), the system switches to a remaining class type and the operation returns to the head of the queue (i.e., back to decision 708). If the head of the queue does not contain a request (decision 708), and if one or more class values do not remain to be processed for the type of class (decision 712), and if one or more class types do not remain to be processed (decision 716), the operation returns. In some aspects, when the operation returns, the network device may continue to perform operations 702-718 for processing and managing all incoming packets to be forwarded via specific output queues.

FIG. 7B presents a flowchart 730 illustrating a method which facilitates providing latency-critical support using the endpoint-class type, in accordance with an aspect of the present application. The system (e.g., by a switch or other network device) may receive a request or packet. In response to receiving the packet, the system determines that the packet is associated with a latency-critical flow (operation 732). The system may make this determination based on fields, flags, or other information indicated in one or more packet headers. The system can also determine the traffic-class value and the endpoint-class value, if indicated in the packet (e.g., in a packet header such as in bit 174 of FTAG 173 of fabric header 171 in FIG. 1).

If any allocated bandwidth remains for the traffic-class value (decision 734), and if any allocated bandwidth remains for the endpoint-class value (decision 736), the system adds the packet to a priority class for a respective endpoint-class value (operation 738) and serves a request associated with the latency-critical flow (operation 740). The system may add the packet to a priority class by placing the packet into a queue with a higher priority and a scheduler component may serve the request from that higher-priority queue by scheduling packets in that queue for forwarding earlier than other lower-priority queues. The operation returns.

If no allocated bandwidth remains for the traffic-class value (decision 734), the system adds the packet to a best-effort class for a respective endpoint-class value (operation 742) and serves a request associated with the latency-critical flow (operation 740). The system may add the packet to a best-effort class by placing the packet into a queue with a medium level of priority. A scheduler component may serve the request from that medium-priority queue by scheduling packets in that queue for forwarding based on a scheduling algorithm that schedules packets from the medium-priority queue earlier than other lower-priority queues and later than a higher-priority queue (e.g., as in operation 738). Other techniques may be used to determine when to serve requests associated with packets in a best-effort class. The operation returns.

If any allocated bandwidth remains for the traffic-class value (decision 734) and if no allocated bandwidth remains for the endpoint-class value (decision 736), the system adds the packet to a best-effort class for a respective endpoint-class value (operation 742) and serves a request associated with the latency-critical flow (operation 740). The operation returns.

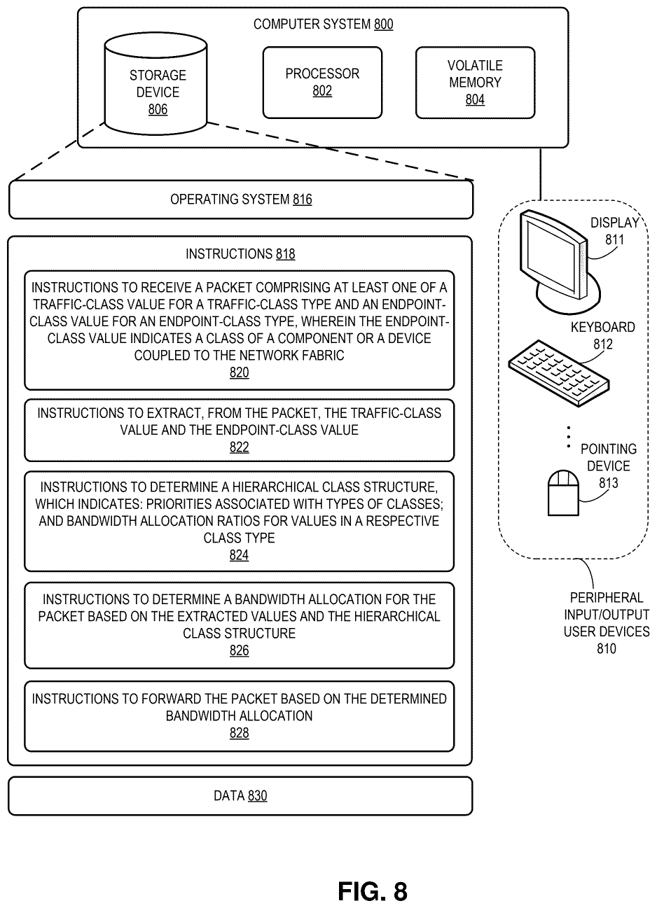

FIG. 8 illustrates a computer system 800 which facilitates endpoint class-based performance isolation in a high-performance interconnect, in accordance with an aspect of the present application. Computer system 800 includes a processor 802, a memory 804, and a storage device 806. Memory 804 may include a volatile memory (e.g., random access memory (RAM)) that serves as a managed memory and can be used to store one or more memory pools. Furthermore, computer system 800 may be coupled to peripheral 1/O user devices 810 (e.g., a display device 811, a keyboard 812, and a pointing device 813). Storage device 806 includes non-transitory computer-readable storage medium and stores an operating system 816, instructions 818, and data 830. Computer system 800 may be a network device 800 with at least one processing resource (e.g., 802) and circuitry (including modules, units, components, etc. in hardware, software, or a combination of hardware and software, e.g., 806). In network device 800, the circuitry or storage device may store instructions which when executed by the at least one processing resource (e.g., 802) comprises instructions to perform the operations described herein. Computer system 800 may include fewer or more entities or instructions than those shown in FIG. 8.

Instructions 818 can include instructions, which when executed by computer system 800, can cause computer system 800 to perform methods and/or processes described in this disclosure. Specifically, instructions 818 may include instructions 820 to receive, by a network device in a network fabric, a packet comprising at least one of a traffic-class value for a traffic-class type and an endpoint-class value for an endpoint-class type, the endpoint-class value indicating a class of a component or a device coupled to the network fabric, as described above in relation to packets 160 and 170 in FIG. 1B and operation 602 of FIG. 6.

Instructions 818 may include instructions 822 to extract, from the packet, the traffic-class value and the endpoint-class value, as described above in relation to packet 170 of FIG. 1B and operation 604 of FIG. 6.

Instructions 818 may include instructions 824 to determine a hierarchical class structure, which indicates: priorities associated with types of classes, comprising a first priority associated with the traffic-class type and a second priority associated with the endpoint-class type; and bandwidth allocation ratios for values in a respective class type, comprising first bandwidth allocation ratios for values of the traffic-class type and second bandwidth allocation ratios for values of the endpoint-class type. Determining a hierarchical class structure is described above in relation to: tables 401, 420, and 440 in FIG. 4; tree data structures 520 and 540 of, respectively, FIGS. 5B and 5C; and operation 606 of FIG. 6.

Instructions 818 may include instructions 826 to determine a bandwidth allocation for the packet based on the extracted values and the hierarchical class structure, as described above in relation to FIGS. 2-4, 5B, and 5C, operation 608 of FIG. 6, and operations 702 and 704 of FIG. 7A

Instructions 818 may include instructions 820 to forward the packet based on the determined bandwidth allocation for the packet, as described above in relation to FIGS. 5B, 5C, 7A, 7B, operation 610 of FIG. 6, and operations 706-718 of FIG. 7A.

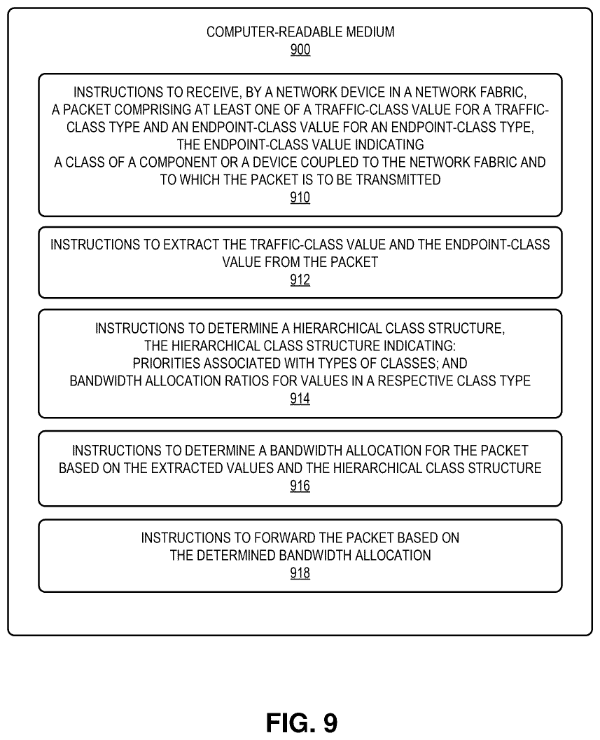

Instructions 818 may include more instructions than those shown in FIG. 8. For example, instructions 818 may include instructions for executing the operations described above in relation to: the environment of FIGS. 1A and 1B; the communications and operations of FIGS. 2 and 3; the assigned weights and hierarchical class structures of FIGS. 4, 5B, and 5C; the operations depicted in the flowcharts of FIGS. 6, 7A, and 7B; and the instructions of CRM 900 in FIG. 9.

Data 830 can include any data that is required as input or that is generated as output by the methods, operations, communications, and/or processes described in this disclosure. Specifically, data 830 can store at least: information associated with a packet; a traffic-class value; a traffic-class type; an endpoint-class value; an endpoint-class type; a source/destination value; a source/destination-class type; a hierarchical class structure; a tree data structure; a bandwidth allocation ratio; a priority; an indicator of a processing-based endpoint class, a storage-based endpoint class, a GPU-based endpoint class, a CPU-based endpoint class, or one or more groups of endpoints, wherein a respective group is associated with a processing-based endpoint, a storage-based endpoint, a GPU-based endpoint, or a CPU-based endpoint; a group of sources or destinations; a header; a packet header; a fabric header; an order in which to traverse a hierarchical class structure or a tree data structure; a queue; a request; an indicator of a latency-critical flow; a priority class; and a best-effort class.

FIG. 9 illustrates a computer-readable medium 900 which facilitates endpoint class-based performance isolation in a high-performance interconnect, in accordance with an aspect of the present application. CRM 900 can be a non-transitory computer-readable medium or device storing instructions that when executed by a computer or processor cause the computer or processor to perform a method. CRM 900 may store instructions 910 to receive, by a network device in a network fabric, a packet comprising at least one of a traffic-class value for a traffic-class type and an endpoint-class value for an endpoint-class type, the endpoint-class value indicating a class of a component or a device coupled to the network fabric and to which the packet is to be transmitted, as described above in relation to packets 160 and 170 in FIG. 1B and operation 602 of FIG. 6.

CRM 900 may store instructions 912 to extract the traffic-class value and the endpoint-class value from the packet, as described above in relation to packet 170 of FIG. 1B and operation 604 of FIG. 6.

CRM 900 may store instructions 914 to determine a hierarchical class structure, the hierarchical class structure indicating: priorities associated with types of classes, comprising a first priority associated with the traffic-class type and a second priority associated with the endpoint-class type; and bandwidth allocation ratios for values in a respective class type, comprising first bandwidth allocation ratios for values of the traffic-class type and second bandwidth allocation ratios for values of the endpoint-class type. Determining a hierarchical class structure is described above in relation to: tables 401, 420, and 440 in FIG. 4; tree data structures 520 and 540 of, respectively, FIGS. 5B and 5C; and operation 606 of FIG. 6.

CRM 900 may store instructions 916 to determine a bandwidth allocation for the packet based on the extracted values and the hierarchical class structure, as described above in relation to FIGS. 2-4, 5B, and 5C, operation 608 of FIG. 6, and operations 702 and 704 of FIG. 7A.

CRM 900 may store instructions 918 to forward the packet based on the determined bandwidth allocation for the packet, as described above in relation to FIGS. 5B, 5C, 7A, 7B, operation 610 of FIG. 6, and operations 706-718 of FIG. 7A.

CRM 900 may include more instructions than those shown in FIG. 9. For example, CRM 900 may also store instructions for executing the operations described above in relation to: the environment of FIGS. 1A and 1B; the communications and operations of FIGS. 2 and 3; the assigned weights and hierarchical class structures of FIGS. 4, 5B, and 5C; the operations depicted in the flowcharts of FIGS. 6, 7A, and 7B; and instructions 818 of computer system 800 in FIG. 8.

Thus, the disclosed aspects extend the non-hierarchical traffic-class type only QoS metrics for traffic management by adding an endpoint-class type and a source/destination-class type. By utilizing configured forwarding priority information (including an order of priority between class types and bandwidth allocation ratios between class values of a given class type), the disclosed aspects can provide additional granularity in forwarding traffic through a network fabric (or other high-performance interconnect), which can result in a more efficient overall system and a more fair distribution of resources.

In general, the disclosed aspects provide a method, a computer system, and a computer-readable medium which facilitate endpoint class-based performance isolation in a high-performance interconnect. During operation, the system receives, by a network device in a network fabric, a packet comprising at least one of a traffic-class value for a traffic-class type and an endpoint-class value for an endpoint-class type, the endpoint-class value indicating a class of a component or a device coupled to the network fabric and to which the packet is to be transmitted. The system extracts the traffic-class value and the endpoint-class value from the packet. The system determines a hierarchical class structure, the hierarchical class structure indicating: priorities associated with types of classes, comprising a first priority associated with the traffic-class type and a second priority associated with the endpoint-class type; and bandwidth allocation ratios for values in a respective class type, comprising first bandwidth allocation ratios for values of the traffic-class type and second bandwidth allocation ratios for values of the endpoint-class type. The system determines a bandwidth allocation for the packet based on the extracted values and the hierarchical class structure. The system forwards the packet based on the determined bandwidth allocation for the packet.

In a variation on this aspect, the endpoint-class value indicates at least one of: a processing-based endpoint class; a storage-based endpoint class; a graphics processing unit (GPU)-based endpoint class; a central processing unit (CPU)-based endpoint class; or one or more groups of endpoints, wherein a respective group is associated with a processing-based endpoint, a storage-based endpoint, a GPU-based endpoint, or a CPU-based endpoint.

In a further variation on this aspect, the packet further comprises a source/destination-class value for a source/destination-class type, and the source/destination-class value indicates a priority between a source of the packet and a destination of the packet. The hierarchical class structure further indicates a third priority associated with the source/destination-class type and third bandwidth allocation ratios for values of the source/destination-class type. The system extracts the source/destination-class value from the packet. The system determines the bandwidth allocation for the packet further based on the extracted source/destination-class value.

In a further variation, the source/destination-class value indicates at least one of: a priority for traffic flowing from a source associated with a first group of sources; a priority for traffic flowing to a source associated with a second group of sources; a priority for traffic flowing from a destination associated with a third group of destinations; or a priority for traffic flowing to a destination associated with a fourth group of destinations.

In a further variation, extracting the traffic-class value, the endpoint-class value, and the source/destination-class value from the packet is based on information indicated in at least one of: a header specific to or associated with the network fabric; or a header associated with a protocol used external to the network fabric.

In a further variation, the priorities, comprising the first priority, the second priority, and the third priority, in the hierarchical class structure indicate an order in which to traverse a tree data structure representing the hierarchical class structure. The bandwidth allocation ratios in the hierarchical class structure correspond to weights for a respective class value of a respective class type.

In a further variation, the traffic-class values comprise two or more values, the endpoint-class values comprise two or more values, and the source/destination-class values comprise two or more values.

In a further variation, determining the bandwidth allocation for the packet comprises: identifying a subclass by traversing the hierarchical class structure, wherein the subclass is associated with a priority indicated in the hierarchical class structure; and adding the packet to a queue corresponding to the identified subclass and associated priority.

In a further variation, forwarding the packet based on the determined bandwidth allocation comprises serving requests associated with packets in the queue by: serving the request for a highest-priority class type based on a head of the queue containing a request; switching to a remaining class value and serving the request based on the head of the queue containing no request, and one or more class values remaining to be processed for the highest-priority class type; and switching to a remaining class type and serving the request based on the head of the queue containing no request, no class values remaining for the highest-priority class type, and one or more class types remaining to be processed.

In a further variation, the system determines that the packet is associated with a latency-critical flow. The system adds the packet to a priority class for a respective endpoint-class value and serves a request associated with the packet based on allocated bandwidth remaining for the traffic-class value and the endpoint-class value. The system adds the packet to a best-effort class and serves a request associated with the packet based on allocated bandwidth remaining for the traffic-class value and no allocated bandwidth remaining for the endpoint-class value. The system adds the packet to a best-effort class and serves a request associated with the packet based on no allocated bandwidth remaining for the traffic-class value.

In a further variation, the hierarchical class structure is specific to and configurable by the network device.

In another aspect, a computer system (e.g., a network device) comprises at least one processing resource and a storage device storing instructions which when executed by the at least one processing resource comprise instructions to receive, by the network device in a network fabric, a packet comprising at least one of a traffic-class value for a traffic-class type and an endpoint-class value for an endpoint-class type, the endpoint-class value indicating a class of a component or a device coupled to the network fabric. The instructions are further to extract, from the packet, the traffic-class value and the endpoint-class value. The instructions are further to determine a hierarchical class structure, which indicates: priorities associated with types of classes, comprising a first priority associated with the traffic-class type and a second priority associated with the endpoint-class type; and bandwidth allocation ratios for values in a respective class type, comprising first bandwidth allocation ratios for values of the traffic-class type and second bandwidth allocation ratios for values of the endpoint-class type. The instructions are further to determine a bandwidth allocation for the packet based on the extracted values and the hierarchical class structure and forward the packet based on the determined bandwidth allocation for the packet. The computer system or network device may include a content-processing system which includes the above-described instructions and instructions to perform the operations described herein, including in relation to: the environment of FIGS. 1A and 1B; the communications and operations of FIGS. 2 and 3; the assigned weights and hierarchical class structures of FIGS. 4, 5B, and 5C; the operations depicted in the flowcharts of FIGS. 6, 7A, and 7B; and the instructions of CRM 900 in FIG. 9.

In another aspect, a non-transitory computer-readable storage medium (or CRM) stores instructions to receive, by a network device in a network fabric, a packet comprising at least one of a traffic-class value for a traffic-class type and an endpoint-class value for an endpoint-class type, the endpoint-class value indicating a class of a component or a device coupled to the network fabric and to which the packet is to be transmitted. The instructions are further to extract the traffic-class value and the endpoint-class value from the packet. The instructions are further to determine a hierarchical class structure, the hierarchical class structure indicating: priorities associated with types of classes, comprising a first priority associated with the traffic-class type and a second priority associated with the endpoint-class type; and bandwidth allocation ratios for values in a respective class type, comprising first bandwidth allocation ratios for values of the traffic-class type and second bandwidth allocation ratios for values of the endpoint-class type. The instructions are further to determine a bandwidth allocation for the packet based on the extracted values and the hierarchical class structure and forward the packet based on the determined bandwidth allocation for the packet. The CRM can also store instructions for executing the operations described above in relation to: the environment of FIGS. 1A and 1B; the communications and operations of FIGS. 2 and 3; the assigned weights and hierarchical class structures of FIGS. 4, 5B, and 5C; the operations depicted in the flowcharts of FIGS. 6, 7A, and 7B; and instructions 818 of computer system 800 in FIG. 8.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method, comprising:
receiving, by a network device in a network fabric, a packet comprising at least one of a traffic-class value for a traffic-class type and an endpoint-class value for an endpoint-class type, the endpoint-class value indicating a class of a component or a device coupled to the network fabric and to which the packet is to be transmitted;
extracting the traffic-class value and the endpoint-class value from the packet;
determining a hierarchical class structure, the hierarchical class structure indicating:
priorities associated with types of classes, comprising a first priority associated with the traffic-class type and a second priority associated with the endpoint-class type; and
bandwidth allocation ratios for values in a respective class type, comprising first bandwidth allocation ratios for values of the traffic-class type and second bandwidth allocation ratios for values of the endpoint-class type;
determining a bandwidth allocation for the packet based on the extracted values and the hierarchical class structure; and
forwarding the packet based on the determined bandwidth allocation for the packet.

2. The method of claim 1, wherein the endpoint-class value indicates at least one of:
a processing-based endpoint class;
a storage-based endpoint class;
a graphics processing unit (GPU)-based endpoint class;
a central processing unit (CPU)-based endpoint class; or
one or more groups of endpoints, wherein a respective group is associated with a processing-based endpoint, a storage-based endpoint, a GPU-based endpoint, or a CPU-based endpoint.

3. The method of claim 1,
wherein the packet further comprises a source/destination-class value for a source/destination-class type, the source/destination-class value indicating a priority between a source of the packet and a destination of the packet,
wherein the hierarchical class structure further indicates a third priority associated with the source/destination-class type and third bandwidth allocation ratios for values of the source/destination-class type, and
wherein the method further comprises:
extracting the source/destination-class value from the packet; and
determining the bandwidth allocation for the packet further based on the extracted source/destination-class value.

4. The method of claim 3, wherein the source/destination-class value indicates at least one of:
a priority for traffic flowing from a source associated with a first group of sources;
a priority for traffic flowing to a source associated with a second group of sources;
a priority for traffic flowing from a destination associated with a third group of destinations; or
a priority for traffic flowing to a destination associated with a fourth group of destinations.

5. The method of claim 3,
wherein extracting the traffic-class value, the endpoint-class value, and the source/destination-class value from the packet is based on information indicated in at least one of:
a header specific to or associated with the network fabric; or
a header associated with a protocol used external to the network fabric.

6. The method of claim 3,
wherein the priorities, comprising the first priority, the second priority, and the third priority, in the hierarchical class structure indicate an order in which to traverse a tree data structure representing the hierarchical class structure, and
wherein the bandwidth allocation ratios in the hierarchical class structure correspond to weights for a respective class value of a respective class type.

7. The method of claim 3,
wherein the traffic-class values comprise two or more values,
wherein the endpoint-class values comprise two or more values, and
wherein the source/destination-class values comprise two or more values.

8. The method of claim 3, wherein determining the bandwidth allocation for the packet comprises:
identifying a subclass by traversing the hierarchical class structure, wherein the subclass is associated with a priority indicated in the hierarchical class structure; and
adding the packet to a queue corresponding to the identified subclass and associated priority.

9. The method of claim 8, wherein forwarding the packet based on the determined bandwidth allocation comprises:
serving requests associated with packets in the queue by:
serving the request for a highest-priority class type based on a head of the queue containing a request;
switching to a remaining class value and serving the request based on the head of the queue containing no request, and one or more class values remaining to be processed for the highest-priority class type; and
switching to a remaining class type and serving the request based on the head of the queue containing no request, no class values remaining for the highest-priority class type, and one or more class types remaining to be processed.

10. The method of claim 3, further comprising:
determining that the packet is associated with a latency-critical flow;
adding the packet to a priority class for a respective endpoint-class value and serving a request associated with the packet based on allocated bandwidth remaining for the traffic-class value and the endpoint-class value;
adding the packet to a best-effort class and serving a request associated with the packet based on allocated bandwidth remaining for the traffic-class value and no allocated bandwidth remaining for the endpoint-class value; and
adding the packet to a best-effort class and serving a request associated with the packet based on no allocated bandwidth remaining for the traffic-class value.

11. The method of claim 1, wherein the hierarchical class structure is specific to and configurable by the network device.

12. A network device, comprising:
at least one processing resource; and
a storage device storing instructions which when executed by the at least one processing resource comprise instructions to:
receive, by the network device in a network fabric, a packet comprising at least one of a traffic-class value for a traffic-class type and an endpoint-class value for an endpoint-class type, the endpoint-class value indicating a class of a component or a device coupled to the network fabric;
extract, from the packet, the traffic-class value and the endpoint-class value;
determine a hierarchical class structure, which indicates:
priorities associated with types of classes, comprising a first priority associated with the traffic-class type and a second priority associated with the endpoint-class type; and
bandwidth allocation ratios for values in a respective class type, comprising first bandwidth allocation ratios for values of the traffic-class type and second bandwidth allocation ratios for values of the endpoint-class type;
determine a bandwidth allocation for the packet based on the extracted values and the hierarchical class structure; and
forward the packet based on the determined bandwidth allocation for the packet.

13. The network device of claim 12,
wherein the packet further comprises a source/destination-class value for a source/destination-class type, the source/destination-class value indicating a priority between a source of the packet and a destination of the packet,
wherein the hierarchical class structure further indicates a third priority associated with the source/destination-class type and third bandwidth allocation ratios for values of the source/destination-class type, and
wherein the instructions are further to:
extract the source/destination-class value from the packet; and
determine the bandwidth allocation for the packet further based on the extracted source/destination-class value.

14. The network device of claim 13,
wherein the endpoint-class value indicates at least one of:
a processing-based endpoint class;
a storage-based endpoint class;
a graphics processing unit (GPU)-based endpoint class;
a central processing unit (CPU)-based endpoint class; or
one or more groups of endpoints, wherein a respective group is associated with a processing-based endpoint, a storage-based endpoint, a GPU-based endpoint, or a CPU-based endpoint; and
wherein the source/destination-class value indicates at least one of:
a priority for traffic flowing from a source associated with a first group of sources;
a priority for traffic flowing to a source associated with a second group of sources;
a priority for traffic flowing from a destination associated with a third group of destinations; or
a priority for traffic flowing to a destination associated with a fourth group of destinations.

15. The network device of claim 13,
wherein extracting the traffic-class value, the endpoint-class value, and the source/destination-class value from the packet is based on information indicated in at least one of:
a header specific to or associated with the network fabric; or
a header associated with a protocol used external to the network fabric.

16. The network device of claim 13,
wherein the priorities, comprising the first priority, the second priority, and the third priority, in the hierarchical class structure indicate an order in which to traverse a tree data structure representing the hierarchical class structure, and
wherein the bandwidth allocation ratios in the hierarchical class structure correspond to weights for a respective class value of a respective class type.

17. The network device of claim 13,
wherein the instructions to determine the bandwidth allocation for the packet are to:
identify a subclass by traversing the hierarchical class structure, wherein the subclass is associated with a priority indicated in the hierarchical class structure; and
add the packet to a queue corresponding to the identified subclass and associated priority; and
wherein the instructions to forward the packet based on the determined bandwidth allocation are further to serve requests associated with packets in the queue by:
serving the request for a highest-priority class type based on a head of the queue containing a request;
switching to a remaining class value and serving the request based on the head of the queue containing no request, and one or more class values remaining to be processed for the highest-priority class type; and
switching to a remaining class type and serving the request based on the head of the queue containing no request, no class values remaining for the highest-priority class type, and one or more class types remaining to be processed.

18. The network device of claim 12, wherein the hierarchical class structure is dynamically configured by the network device and specific to the network device.

19. A non-transitory computer-readable medium storing instructions to:
receive, by a network device in a network fabric, a packet comprising at least one of a traffic-class value for a traffic-class type and an endpoint-class value for an endpoint-class type, the endpoint-class value indicating a class of a component or a device coupled to the network fabric and to which the packet is to be transmitted;
extract the traffic-class value and the endpoint-class value from the packet;
determine a hierarchical class structure, the hierarchical class structure indicating:
priorities associated with types of classes, comprising a first priority associated with the traffic-class type and a second priority associated with the endpoint-class type; and
bandwidth allocation ratios for values in a respective class type, comprising first bandwidth allocation ratios for values of the traffic-class type and second bandwidth allocation ratios for values of the endpoint-class type;
determine a bandwidth allocation for the packet based on the extracted values and the hierarchical class structure; and
forward the packet based on the determined bandwidth allocation for the packet.

20. The non-transitory computer-readable medium of claim 19,
wherein the packet further comprises a source/destination-class value for a source/destination-class type, the source/destination-class value indicating a priority between a source of the packet and a destination of the packet,
wherein the hierarchical class structure further indicates a third priority associated with the source/destination-class type and third bandwidth allocation ratios for values of the source/destination-class type, and
wherein the instructions are further to:
extract the source/destination-class value from the packet; and
determine the bandwidth allocation for the packet further based on the extracted source/destination-class value.
